(19) United States
(12) Patent Application Publication
(10) Pub. No.: US 2014/0079328 A1
(43) Pub. Date: Mar. 20, 2014

(54) ENCODING APPARATUS, DECODING APPARATUS, AND SWITCHER APPARATUS

(71) Applicant: Sony Corporation, Tokyo (JP)

(72) Inventor: Hiroshi Arai, Kanagawa (JP)

(73) Assignee: Sony Corporation, Tokyo (JP)

(21) Appl. No.: 14/016,283

(22) Filed: Sep. 3, 2013

(30) Foreign Application Priority Data
Sep. 14, 2012 (JP) 2012-203602

(51) Int. Cl. G06T 9/20

(52) U.S. Cl. CPC G06T 9/20
USPC 382/233; 382/242

(57) ABSTRACT

An encoding apparatus includes: an extraction unit to extract a boundary component from image data; a first frequency decomposition unit to perform frequency decomposition on the remaining image data to obtain a first low-frequency component and a first high-frequency component; a low-frequency signal processing unit to perform signal processing on the first low-frequency component; a high-frequency signal processing unit to perform signal processing on the first high-frequency component; a boundary component signal processing unit configured to perform signal processing on the extracted boundary component; a second frequency decomposition unit to perform frequency decomposition on the boundary component to obtain a second low-frequency component and a second high-frequency component; a coding unit to perform entropy coding on the first high-frequency component, the second low-frequency and high-frequency components; and a transmission unit to transmit the first low-frequency component, the coded second low-frequency component, and the coded first and second high-frequency components.

### BACKGROUND

The present disclosure relates to an encoding apparatus, a decoding apparatus, and a switcher apparatus that are suitable for transmission of high-definition image data.

In recent years, high-definition television broadcasting has been progressing, and high-definition linages such as 4K high-definition images and 8K ultra high-definition images have been increasingly used.

The 4K high-definition images and the 8K ultra high-definition images are each transmitted in a compressed form. On the other hand, for image processing of the 4K high-definition images and the 8K ultra high-definition images, baseband (uncompressed) processing is still performed thereon.

For example, Japanese Patent Application Laid-open No. 2904-326447 discloses a technique related to an image synthesizing apparatus capable of synthesizing and coding two images at a stage at which signals coded according to JPEG-2000 specifications are EBCOT-decoded. The image synthesizing apparatus disclosed in Japanese Patent Application Laid-open. No. 2004-326447 decodes encoded code streams, which are encoded according to JPEG-2000 specifications, and generates quantization coefficients of every code block. In a cross fade part, the quantization coefficients are multiplied by coefficients α(t) and (1−α(t)) by adders and added by an adder so that a cross fade quantized coefficient can be obtained. Then, the cross fade quantization coefficient is encoded, and a final encoded code stream is output. According to the image synthesizing apparatus disclosed in Japanese Patent Application Laid-open No. 2004-326447, the effect that the two encoded code streams are synthesized at a less memory usage amount and in an effective manner is advocated.

### SUMMARY

The data amount of 4K high-definition images and 8K ultra high-definition images is huge. In an encoding apparatus and an image processing apparatus (switcher apparatus or the like) or a decoding apparatus, when general signal processing is performed on those high-definition images as image processing, a total amount of operations for the signal processing also becomes huge. Recently, speed-up in arithmetic processing units such as CPUs (Central Processing Unit) has been significantly improved. However, such arithmetic processing units lead to necessity of larger LSIs (Large Scale Integration) and the like, and an increase in size and power consumption of necessary hardware resources has been inevitable.

In view of the circumstances as described above, it is desirable to provide an encoding apparatus, a decoding apparatus, and a switcher apparatus that are capable of reducing the size of hardware resources for signal processing.

According to an embodiment of the present disclosure, there is provided an encoding apparatus including an extraction unit, a first frequency decomposition unit, a low-frequency signal processing unit, a high-frequency signal processing unit, a boundary component signal processing unit, a second frequency decomposition unit, a coding unit, and a transmission unit. The extraction unit is configured to extract a boundary component from image data, the boundary component being a target of local image processing. The first frequency decomposition unit is configured to perform frequency decomposition on the remaining image data from which the boundary component is extracted, to obtain a first low-frequency component and a first high-frequency component. The low-frequency signal processing unit is configured to perform signal processing on the first low-frequency component obtained by the frequency decomposition. The high-frequency signal processing unit is configured to perform signal processing on the first high-frequency component obtained by the frequency decomposition. The boundary component signal processing unit is configured to perform signal processing on the extracted boundary component. The second frequency decomposition unit is configured to perform frequency decomposition on the boundary component subjected to the signal processing, to obtain a second low-frequency component and a second high-frequency component. The coding unit is configured to perform entropy coding on the first high-frequency component, the second low-frequency component, and the second high-frequency component, the first high-frequency component being subjected to the signal processing, the second low-frequency component and the second high-frequency component being subjected to the frequency decomposition. The transmission unit is configured to transmit the first low-frequency component, the coded second low-frequency component, the coded first high-frequency component, and the coded second high-frequency component.

The encoding apparatus may further include a preceding-stage signal processing unit configured to perform signal processing on the image data before extracting the boundary component, the signal processing excluding the signal processing performed in the low-frequency signal processing unit, the high-frequency signal processing unit, and the boundary component signal processing unit.

According to another embodiment of the present disclosure, there is provided a decoding apparatus including an input unit, a separation unit, an entropy decoding unit, and an inverse frequency transform unit. The input unit is configured to input image data transmitted from an encoding apparatus, the encoding apparatus including an extraction unit configured to extract a boundary component from image data, the boundary component being a target of local image processing, a first frequency decomposition unit configured to perform frequency decomposition on the remaining image data from which the boundary component is extracted, to obtain a first low-frequency component and a first nigh-frequency component, a low-frequency signal processing unit configured to perform signal processing on the first low-frequency component obtained by the frequency decomposition, a high-frequency signal processing unit configured to perform signal processing on the first high-frequency component obtained by the frequency decomposition, a boundary component signal processing unit configured to perform signal processing on the extracted boundary component, a second frequency decomposition unit configured to perform frequency decomposition on the boundary component subjected to the signal processing,, to obtain a second low-frequency component and a second high-frequency component, a coding unit configured to perform entropy coding on the first high-frequency component, the second low-frequency component, and the second high-frequency component, the first, high-frequency component being subjected to the signal processing, the second low-frequency component and the second high-frequency component being subjected to the frequency decomposition, and a transmission unit configured to transmit the first low-frequency component, the coded second low-frequency component, the coded first, high-frequency component, and the coded second high-frequency component. The separation unit is configured to separate a first low-frequency component and a second low-frequency component from the input image data to generate image data with a first resolution. The entropy decoding unit is configured to perform entropy decoding on the input image data. The inverse frequency transform unit is configured to perform inverse frequency decomposition on the image data subjected to the entropy decoding to generate image data with a second resolution higher than the first resolution.

According to another embodiment of the present disclosure, there is provided a switcher apparatus including an input unit, a selection unit, at least one entropy decoding unit, at least one signal processing unit, a second coding unit, and a second transmission unit. The input unit is configured to input a plurality of image data items transmitted from a plurality of encoding apparatuses, the plurality of encoding apparatuses each including an extraction unit configured to extract a boundary component from image data, the boundary component being a target of local image processing, a first frequency decomposition unit configured to perform frequency decomposition on the remaining image data from which the boundary component is extracted, to obtain a first low-frequency component and a first high-frequency component, a low-frequency signal processing unit configured to perform signal processing on the first low-frequency component obtained by the frequency decomposition, a high-frequency signal processing unit configured to perform signal processing on the first high-frequency component obtained by the frequency decomposition, a boundary component signal processing unit configured to perform signal processing on the extracted boundary component, a second frequency decomposition unit configured to perform frequency decomposition on the boundary component subjected to the signal processing, to obtain a second low-frequency component and a second high-frequency component, a first coding unit configured to perform entropy coding on the first high-frequency component, the second low-frequency component, and the second high-frequency component, the first high-frequency component being subjected to the signal processing, the second low-frequency component and the second high-frequency component being subjected to the frequency decomposition, and a first transmission unit configured to transmit the first low-frequency component, the coded second low-frequency component, the coded first high-frequency component, and the coded second high-frequency component. The selection unit is configured to select at least one image data item from the plurality of input image data items. The at least one entropy decoding unit is configured to perform entropy decoding on the selected at least one image data item. The at least one signal processing unit is configured to perform signal processing on the at least one image data item subjected to the entropy decoding. The second coding unit is configured to perform entropy coding on the at least one image data item subjected to the signal processing. The second transmission unit is configured to transmit the at least one image data item subjected to the entropy coding.

As described above, according to the present disclosure, it is possible to achieve a reduction in size of hardware resources for signal processing and in power consumption.

These and other objects, features and advantages of the present disclosure will become mere apparent in light of the following detailed description of best mode embodiments thereof, as illustrated in the accompanying drawings.

### BRIEF DESCRIPTION OF DRAWINGS

FIG. 1 is a block diagram showing a configuration of an encoding apparatus according to a first embodiment of the present disclosure;

FIG. 2 is a flowchart showing an operation of the encoding apparatus shown in FIG. 1;

FIG. 3 is a block diagram showing a configuration of a decoding apparatus according to the first embodiment of the present disclosure;

FIG. 4 is a flowchart showing an operation of the decoding apparatus shown in FIG. 3;

FIG. 5 is a block diagram showing a configuration of a switcher apparatus according to the first embodiment of the present disclosure; and

FIG. 6 is a flowchart showing the switcher apparatus shown in FIG. 5.

### DETAILED DESCRIPTION OF EMBODIMENTS

Hereinafter, description will be given on a first embodiment of the present disclosure with reference to the drawings.

### First Embodiment

This embodiment relates to an encoding apparatus and a decoding apparatus that are suitable for signal processing of high-definition image data.

(Configuration of Encoding Apparatus)

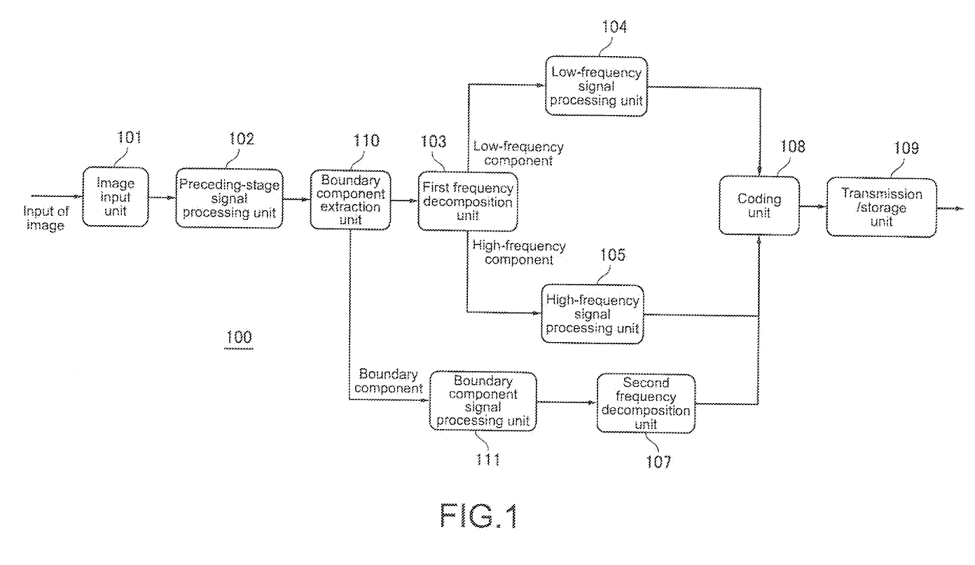

FIG. 1 is a block diagram showing a configuration of an encoding apparatus 100 according to the first embodiment of the present disclosure.

The encoding apparatus 100 includes an image input unit 101, a preceding-stage signal processing unit 102, a boundary component extraction unit 110 (extraction unit), a first frequency decomposition unit 103, a low-frequency signal processing unit 104, a high-frequency signal processing unit 105, a boundary component signal processing unit 111, a second frequency decomposition unit 107, a coding unit 108, and a transmission/storage unit 109 (transmission unit).

The image input unit 101 inputs high-definition image data, which is supplied from an imaging apparatus such as a high-speed camera (not shown), and supplies the high-definition image data to the preceding-stage signal processing unit 102.

The preceding-stage signal processing unit 102 performs baseband signal processing at a preceding stage of frequency decomposition processing, by algorithms such as corrupted data correction processing, aberration correction processing, image reversal processing, and horizontal/vertical movement processing, in which it is difficult to perform image processing in a frequency-decomposed state of signals.

The boundary component extraction unit 110 determines a pixel, which is intended to be processed without change, separates and extracts the pixel as a boundary component, and supplies the pixel to the boundary component signal processing unit 111. The remaining components are supplied to the first frequency decomposition unit 103.

The first frequency decomposition unit 103 discomposes the high-definition image data, which is supplied from the boundary component extraction unit 110, into a low-frequency component and a high-frequency component by a frequency decomposition algorithm such as wavelet transform. The first frequency decomposition unit 103 supplies the low-frequency component, which is obtained by the frequency decomposition performed on the high-definition image data, to the low-frequency signal processing unit 104. Further, the first frequency decomposition unit 103 supplies the high-frequency component, which is obtained by the frequency decomposition performed on the high-definition image data, to the high-frequency signal processing unit 105.

The low-frequency signal processing unit 104 performs signal processing designated in advance by a user on the low-frequency component obtained by the frequency decomposition performed on the high-definition image data by the first frequency decomposition unit 103. The type of signal processing will be described later.

The high-frequency signal processing unit 105 performs simplified signal processing designated in advance by a user on the high-frequency component obtained by the frequency decomposition performed on the high-definition image data by the first frequency decomposition unit 103. The type of signal processing will be described later.

The boundary component signal processing unit 111 performs signal processing designated in advance by a user on the boundary component extracted from the high-definition image data by the boundary component extraction unit 110.

The second frequency decomposition unit 107 decomposes the data supplied from the boundary component signal processing unit 111 into a low-frequency component and a high-frequency component by a frequency decomposition algorithm such as wavelet transform.

The coding unit 108 (compression coding unit) compresses and codes the low-frequency components and the high-frequency components by entropy coding. The low-frequency components and the high-frequency components that are obtained after the signal processing are supplied from the low-frequency signal processing unit 104, the high-frequency signal processing unit 105, and the second frequency decomposition unit 107. Examples of the method of entropy coding include a variable-length coding and a fixed-length coding.

The transmission/storage unit 109 transmits the compressed data that is coded in the coding unit 108 or stores it in a predetermined storage device.

(Operation of Encoding Apparatus 100)

Next, an operation of the encoding apparatus 100 will be described.

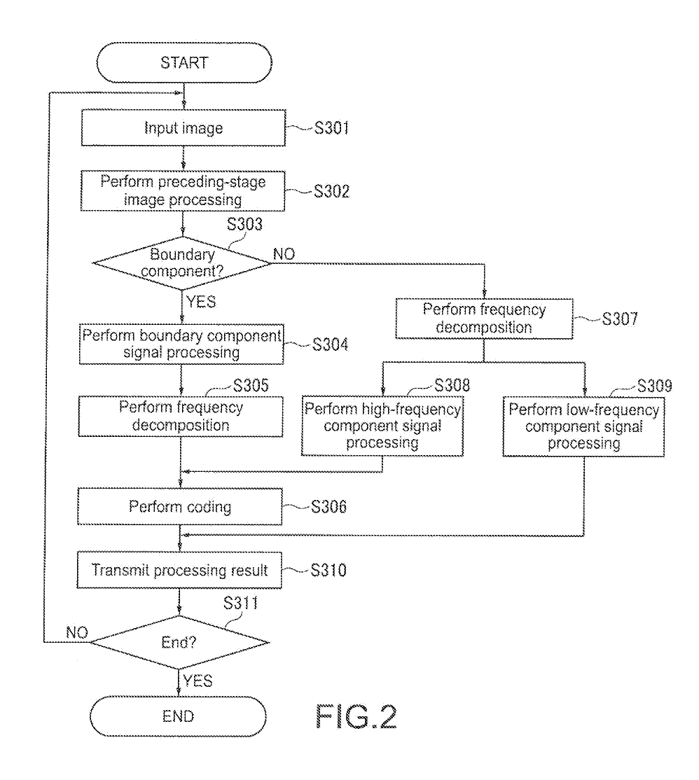

FIG. 2 is a flowchart showing an operation of the encoding apparatus 100.

First, initialization processing is performed on a register and a memory in the encoding apparatus 100. Upon completion of the initialization, the image input unit 101 inputs high-definition image data, which is supplied from an imaging apparatus such as a high-speed camera (Step S301).

The preceding-stage signal processing unit 102 performs baseband signal processing by algorithms such as corrupted data correction processing, aberration correction processing, image reversal processing, and horizontal/vertical movement processing, in which it is difficult to perform signal processing (image processing) in a frequency-decomposed state of signals (Step S302).

The boundary component extraction unit 110 determines a pixel, which is intended to be processed without change, that is, whether the pixel is a boundary component or not (Step S303). By this determination, a spot on which image processing is intended to be locally performed is extracted as a boundary component.

In the case where a pixel to be processed is a boundary component (Step S303/Yes), the boundary component signal processing unit 111 performs signal processing designated in advance by a user on the boundary component (Step S304).

The second frequency decomposition unit 107 decomposes the high-definition image data supplied from the boundary component signal processing unit 111 into a low-frequency component and a high-frequency component by a frequency decomposition algorithm such as wavelet transform (Step S305). The second frequency decomposition unit 107 supplies the low- and high-frequency components obtained by the frequency decomposition performed on the high-definition image data to the coding unit 108.

In Step S303, in the case where the pixel to be processed is not a boundary component (Step S303/No), the first frequency decomposition unit 103 discomposes the high-definition image data, which is supplied from the boundary component extraction unit 110, into a low-frequency component and a high-frequency component by a frequency decomposition algorithm such as wavelet transform (Step S307). The first frequency decomposition unit 103 supplies the low-frequency component, which is obtained by the frequency decomposition performed on the high-definition image data, to the low-frequency signal processing unit 104. Further, the first frequency decomposition unit 103 supplies the high-frequency component, which is obtained by the frequency decomposition performed on the high-definition image data, to the high-frequency signal processing unit 105.

The low-frequency signal processing unit 104 performs signal processing designated in advance by a user on the low-frequency component of the image data (Step S309). Since results subjected to the signal processing are not coded, the results are directly supplied to the transmission/storage unit 109. The signal processing performed herein includes processing uniquely performed on an image, such as white balance adjustment, black balance adjustment, flare adjustment, saturation adjustment, matrix adjustment, gamma adjustment, knee adjustment, and white clip adjustment.

The high-frequency signal processing unit 105 performs signal processing designated in advance by a user on the high-frequency component by simplified methods (Step S308) and supplies results of the signal processing to the coding unit 108.

Here, the simplified methods are specifically as follows.

1. To directly perform signal processing on the high-frequency component.

2. To perform no processing depending on types of processing. For example, white balance adjustment and the like are not performed practically.

In such a manner, the high-frequency component on which the signal processing is performed by the high-frequency signal processing unit 105, and the low-frequency component and high-frequency component on which the signal processing is performed by the boundary component signal processing unit 111 and decomposed by the second frequency decomposition unit 107, are subjected to entropy coding in the coding unit 108 (Step S306), and then transmitted or stored in a predetermined storage device by the transmission/storage unit 109 (Step S310).

The operation described above is repeated while image data is successively supplied from an imaging apparatus such as a high-speed camera (Step S311).

It should be noted that the frequency decomposition performed by the first frequency decomposition unit 103 and the second frequency decomposition unit 107 may be performed once or a plurality of times. For example, in the case where the frequency decomposition is performed twice and raw image data, is an 8K ultra high-definition video, a low-frequency component with 4K size (low-frequency component at the first level) is obtained by the first frequency decomposition. Further, a lowest-frequency component with HD (High Definition) size (low-frequency component at the second level) is obtained from the low-frequency component with 4K size by the second frequency decomposition. The low-frequency component to be processed in the low-frequency signal processing unit 104 may be any of the low-frequency component at the first level and the low-frequency component at the second level and is selectable depending on settings.

(Configuration of Decoding Apparatus 300)

Next, description will be given on a decoding apparatus 300 to be used in combination with the encoding apparatus 100 according to the embodiment described above.

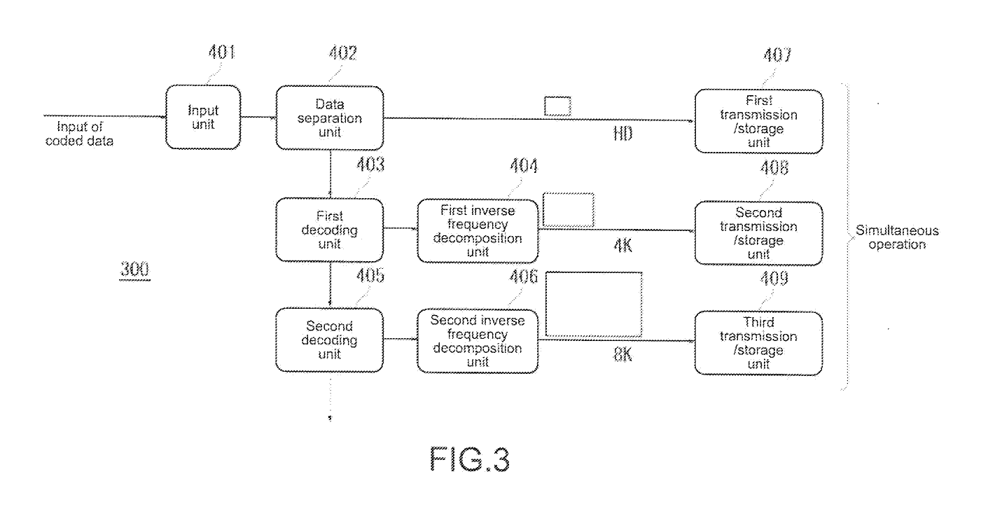

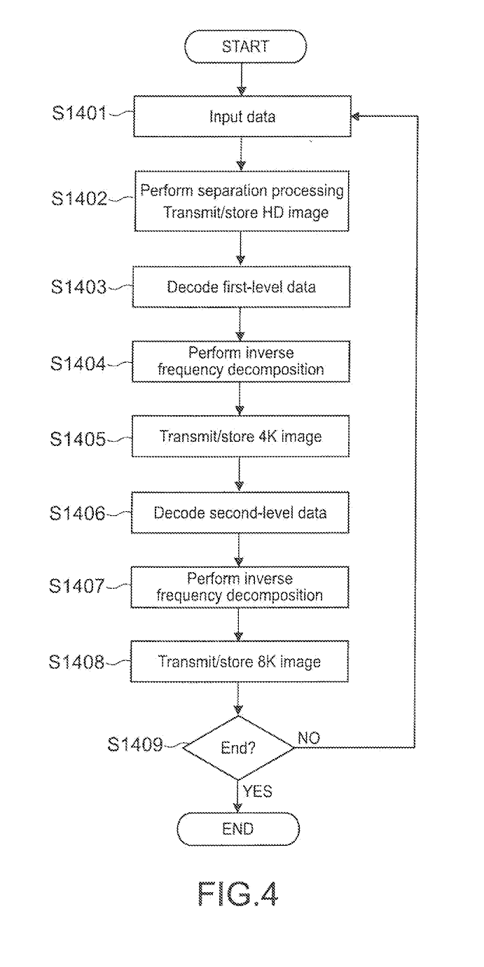

FIG. 3 is a block diagram showing a configuration of the decoding apparatus 300 in this embodiment. FIG. 4 is a flowchart showing an operation of the decoding apparatus 300.

The decoding apparatus 300 includes an input unit 401, a data separation unit 402 (separation unit), a first decoding unit 403 (entropy decoding unit), a first inverse frequency decomposition, unit 404 (inverse frequency transform unit), a second decoding unit 405, a second inverse frequency decomposition unit 406, a first transmission/storage unit 407, a second transmission/storage unit 408, and a third transmission/storage unit 409.

The input unit 401 inputs image data coded in the encoding apparatus 100 (Step S1401) and supplies the data to the data separation unit 402. It should be noted that the coded image data to be input is assumed to be an 8K ultra high-definition video on which two-level frequency decomposition is performed.

In order to display images on an HD monitor, a 4K monitor, and an 8K monitor, the data separation unit 402 separates a lowest-frequency component with HD size (low-frequency component at the second level) from the input 8K image data and transmits the lowest-frequency component to the first transmission/storage unit 407 associated with the HD monitor. Simultaneously, the data separation unit 402 separates a low-frequency component with 4K size (low-frequency component at the first level) from the 8K image data to supply the low-frequency component to the first decoding unit 403, and supplies the image data with 8K size to the second decoding unit 405 as it is (Step S1402).

The first decoding unit 403 (first-level decoding unit) performs entropy decoding on the low-frequency component with 4K size (low-frequency component at the first level), which is supplied from the data separation unit 402, and supplies the resultant component to the first inverse frequency decomposition unit 404 (Step S1403). The first inverse frequency decomposition unit 404 generates 4K size image data by performing inverse frequency decomposition on the image data supplied from the first decoding unit 403 (Step S1404), and supplies the resultant data to the second transmission/storage unit 408 associated with the 4K monitor (Step S1405).

Further, the second decoding unit 405 (second-level decoding unit) performs entropy decoding on the 8K size image data, which is supplied from the data separation unit 402, and supplies the resultant data to the second inverse frequency decomposition unit 406 (Step S1406). The second inverse frequency decomposition unit 406 generates 8K size image data by performing inverse frequency decomposition on the image data supplied from the second decoding unit 405 (Step S1407), and supplies the resultant data to the third transmission/storage unit 409 associated with the 8K monitor (Step S1408).

The operation described above is repeated while coded image data is successively supplied from the encoding apparatus 100 (Step S1409).

(Configuration of Switcher Apparatus)

Next, description will be given on a switcher apparatus that, is used as a unit to select image data and is provided with a unit to perform signal processing on frequency decomposition images and the like coded in the encoding apparatus 100 described above to transmit the resultant image to a subsequent stage.

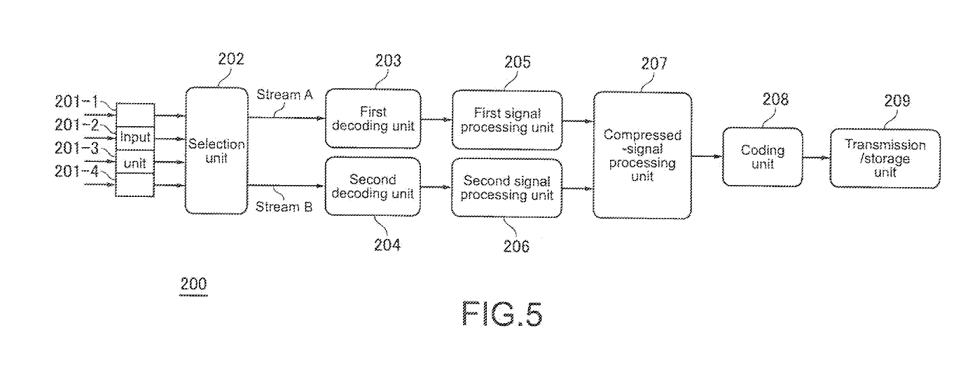

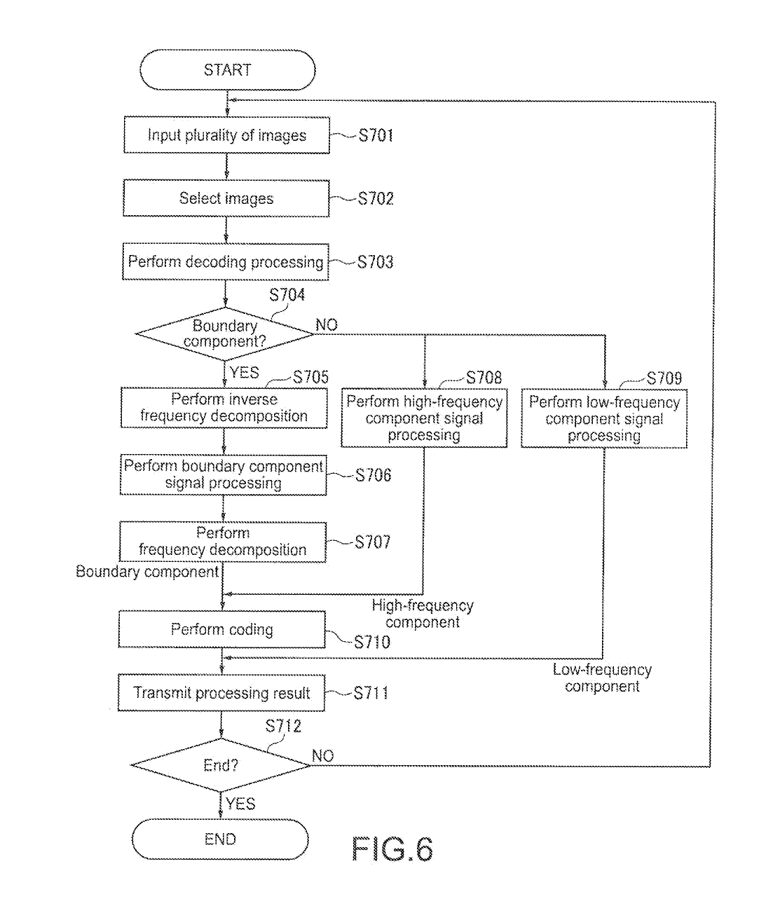

FIG. 5 is a block diagram showing a configuration of a switcher apparatus 200 according to the embodiment of the present disclosure. FIG. 6 is a flowchart of an operation of the switcher apparatus 200.

The switcher apparatus 200 includes a plurality of input units 201-1 to 201-4, a selection unit 202, a first decoding unit 203 (entropy decoding unit), a second decoding unit 204, a first signal processing unit 205 (signal processing unit), a second signal processing unit 206, a compressed-signal processing unit 207 (composition processing unit), a coding unit 208 (second coding unit), and a transmission/storage unit 209 (second transmission unit).

For example, in the case where the plurality of encoding apparatuses 100 described above exist, the plurality of input units 201-1 to 201-4 take in a plurality of image data items that are coded in the respective encoding apparatuses 100 and supply the data items to the selection unit 202 (Step S701).

The selection unit 202 selects image data items to be transmitted to a subsequent stage from the plurality of image data items (Step S702). Here, assumed is a case where two images (stream A and stream B) are selected from four image data items. One of the images, that is, the stream A, is supplied to the first decoding unit 203 and the other image, the stream B, is supplied to the second decoding unit 204.

The first decoding unit 203 decodes the image (stream A) supplied from the selection unit 202 and supplies the resultant image to the first signal processing unit 205.

The second decoding unit 204 decodes the image (stream B) supplied from the selection unit 202 and supplies the resultant image to the second signal processing unit 206 (Step S703).

The first signal processing unit 205 performs signal processing on image data including a low-frequency component and a high-frequency component, which are obtained by the decoding by the first decoding unit 203. Then, the first signal processing unit 205 supplies the resultant data to the compressed-signal processing unit 207. Here, the signal processing may be performed on only the low-frequency component or may be performed on both of the low-frequency component and the high-frequency component.

On the other hand, the second signal processing unit 206 also performs signal processing on image data including a low-frequency component and a high-frequency component, which are obtained by the decoding by the second decoding unit 204. Then, the second signal-processing unit 206 supplies the resultant data to the compressed-signal processing unit 207.

It should be noted that the signal processing capable of being performed in the first signal processing unit 205 and the second signal processing unit 206 includes processing uniquely performed on an image, such as white balance adjustment, black balance adjustment, flare adjustment, saturation adjustment, matrix adjustment, gamma adjustment, knee adjustment, and white clip adjustment.

The compressed-signal processing unit 207 determines whether the two image data items supplied from the first signal processing unit 205 and the second signal processing unit 206 are boundary components or not (Step S704). The boundary components refer to portions to be boundaries of the two images to be combined by wipe processing or key processing, that is, spots on which image processing is intended to be locally performed by the compressed-signal processing unit 207.

In the case where the two image data items are boundary components (Step S704/Yes), that is, boundaries in wipe processing or key processing, the compressed-signal processing unit 207 extracts the boundary components and after performing inverse frequency decomposition thereon (Step S705), performs signal processing thereon (Step S706), and then performs frequency decomposition again (Step S707).

In Step S704, in the case where the two image data items are not boundary components (Step S704/No), the compressed-signal processing unit 207 performs signal processing on the high-frequency components and the low-frequency components (Step S708 and S709). In this manner, the compressed-signal processing unit 207 performs image processing on each of the low-frequency components, the high-frequency components, and the boundary components of the image data.

The image processing performed in the compressed-signal processing unit 207 may be image composition such as Wipe, Mix, Chroma key, PinP, and insert of logos and telop.

The high-frequency components and boundary components of the composite image are subjected to entropy coding in the coding unit 208 (Step S710) and then supplied to the transmission/storage unit 209 at the subsequent stage (Step S711). The low-frequency components of the composite image are supplied to the transmission/storage unit 209 without being coded.

(Mix Processing)

The compressed-signal processing unit 207 mixes the low-frequency components of the two image data items at any proportion and mixes only the high-frequency components of the two image data items, which have a predetermined threshold vale or larger, at any proportion.

(Wipe Processing)

Wipe is processing of switching from one original image to the next image like wiping.

The compressed-signal processing unit 207 performs wipe processing on the low-frequency components of the two image data items and performs wipe processing on only the high-frequency components of the two image data items, which have a predetermined threshold vale or larger. At this time, the compressed-signal processing unit 207 performs inverse frequency transform on only the boundary components as necessary, the boundary components being boundaries at division parts between the two images, and after performing the wipe processing similar to that performed on the low-frequency components, performs frequency transform again to recover the original state of the frequency decomposition image.

PinP processing, Chroma key processing, processing of inserting logos and telop, and the like are performed in a way similar to the wipe processing.

(Effects and the Like of This Embodiment)

When signal processing generally performed for baseband signals is performed on high-resolution images such as 4K high definition images and 8K ultra high-definition images, a large DSP (digital signal processing apparatus) and the like are used, which causes an increase in the size of hardware resources, an increase in power consumption, and the like. On the other hand, in the decoding apparatus 100 of this embodiment, certain signal processing is performed on low-frequency components of frequency decomposition images, for example, or on only boundary components thereof. Accordingly, the whole amount of operations is reduced, a small hardware configuration is achieved, and power consumption is also reduced.

Further, according to this embodiment, image transmission and storage among the encoding apparatus 100, the switcher apparatus 200, and the decoding apparatus 300 are performed in a state of a compressed image on which frequency decomposition is performed. Therefore, it is also possible to improve image transmission efficiency.

The method and apparatus for processing high-definition image data captured with a high-speed camera and the like have been described in the above. In order to achieve a reduction in size of hardware for signal processing and the like, the present disclosure is also applicable to apparatuses that process any other image data captured with motion-picture cameras, video cameras, and the like.

The present disclosure contains subject matter related to that disclosed in Japanese Priority Patent Application JP 2012-203602 filed in the Japan Patent Office on Sep. 14, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An encoding apparatus, comprising:
an extraction unit configured to extract a boundary component from image data, the boundary component being a target of local image processing;
a first frequency decomposition unit configured to perform frequency decomposition on the remaining image data from which the boundary component is extracted, to obtain a first low-frequency component and a first high-frequency component;
a low-frequency signal processing unit configured to perform signal processing on the first low-frequency component obtained by the frequency decomposition;
a high-frequency signal processing unit configured to perform signal processing on the first high-frequency component obtained by the frequency decomposition;
a boundary component signal processing unit configured to perform signal processing on the extracted boundary component;
a second frequency decomposition unit configured to perform frequency decomposition on the boundary component subjected to the signal processing, to obtain a second low-frequency component and a second high-frequency component;
a coding unit configured to perform entropy coding on the first high-frequency component, the second low-frequency component, and the second high-frequency component, the first high-frequency component being subjected to the signal processing, the second low-frequency component and the second high-frequency component being subjected to the frequency decomposition; and
a transmission unit configured to transmit the first low-frequency component, the coded second low-frequency component, the coded first high-frequency component, and the coded second high-frequency component.

2. The encoding apparatus according to claim 1, further comprising a preceding-stage signal processing unit configured to perform signal processing on the image data before extracting the boundary component, the signal processing excluding the signal processing performed in the low-frequency signal processing unit, the high-frequency signal processing unit, and the boundary component signal processing unit.

3. A decoding apparatus, comprising:
an input unit configured to input image data transmitted, from an encoding apparatus, the encoding apparatus including
an extraction unit configured to extract a boundary component from image data, the boundary component being a target of local image processing,
a first frequency decomposition unit configured to perform frequency decomposition on the remaining image data from which the boundary component is extracted, to obtain a first low-frequency component and a first high-frequency component,
a low-frequency signal processing unit configured to perform signal processing on the first low-frequency component obtained by the frequency decomposition,
a high-frequency signal processing unit configured to perform signal processing on the first high-frequency component obtained by the frequency decomposition,
a boundary component signal processing unit configured to perform signal processing on the extracted boundary component,
a second frequency decomposition unit configured to perform frequency decomposition on the boundary component subjected to the signal processing, to obtain a second low-frequency component and a second high-frequency component,
a coding unit configured to perform entropy coding on the first high-frequency component, the second low-frequency component, and the second high-frequency component, the first high-frequency component being subjected to the signal processing, the second low-frequency component and the second high-frequency component being subjected to the frequency decomposition, and
a transmission unit configured to transmit the first low-frequency component, the coded second low-frequency component, the coded first high-frequency component, and the coded second high-frequency component;
a separation unit configured to separate a first low-frequency component and a second low-frequency component from the input image data to generate image data with a first resolution;
an entropy decoding unit configured to perform entropy decoding on the input image data; and
an inverse frequency transform unit configured to perform inverse frequency decomposition on the image data subjected to the entropy decoding to generate image data with a second resolution higher than the first resolution.

4. A switcher apparatus, comprising:
an input unit configured to input a plurality of image data items transmitted from a plurality of encoding apparatuses, the plurality of encoding apparatuses each including
an extraction unit configured to extract a boundary component from image data, the boundary component being a target of local image processing,
a first frequency decomposition unit configured to perform frequency decomposition on the remaining image data from which the boundary component is extracted, to obtain a first low-frequency component and a first high-frequency component,
a low-frequency signal processing unit configured to perform signal processing on the first low-frequency component obtained by the frequency decomposition,
a high-frequency signal processing unit configured to perform signal processing on the first high-frequency component obtained by the frequency decomposition,
a boundary component signal processing unit configured to perform signal processing on the extracted boundary component,
a second frequency decomposition unit configured to perform frequency decomposition on the boundary component subjected to the signal processing, to obtain a second low-frequency component and a second high-frequency component,
a first coding unit configured to perform entropy coding on the first high-frequency component, the second low-frequency component, and the second high-frequency component, the first high-frequency component being subjected to the signal processing, the second low-frequency component and the second high-frequency component being subjected to the frequency decomposition, and
a first transmission unit configured to transmit the first low-frequency component, the coded second low-frequency component, the coded first high-frequency component, and the coded second high-frequency component;
a selection unit configured to select at least one image data item from the plurality of input image data items;
at least one entropy decoding unit configured to perform entropy decoding on the selected at least one image data item;
at least one signal processing unit configured to perform signal processing on the at least one image data item subjected to the entropy decoding;
a second coding unit configured to perform entropy coding on the at least one image data item subjected to the signal processing; and
a second transmission unit configured to transmit the at least one image data item subjected to the entropy coding.
